(19) United States
(12) Patent Application Publication
(10) Pub. No.: US 2004/0069401 A1
(43) Pub. Date: Apr. 15, 2004

(54) Wasteless laminator

(76) Inventors: Grant H. Wurdell, Minnetonka, MN (US); Steven J. Fitzsimmons, Eden Prairie, MN (US)

Correspondence Address: MERCHANT & GOULD PC, P.O. BOX 2903, MINNEAPOLIS, MN, 55402-0903, US

(21) Appl. No.: 10/608,583

(22) Filed: Jun. 23, 2003

Related U.S. Application Data
(60) Provisional application No. 60/395,601, filed on Jul. 11, 2002.

(51) Int. Cl. C09J 1/00; B32B 31/00; B26D 5/00

(52) U.S. Cl. 156/247; 156/344; 156/250; 156/355; 156/510; 156/582

(57) ABSTRACT

A wasteless lamination mechanism that laminates a topcoat or lamina onto a substrate, without requiring cutting of the lamina down to the size of the substrate. The substrate is preferably a card, such as an identification card, a credit card, or other CR80 size card. A lamina to be laminated onto a substrate is separated from a web containing a plurality of lamina after lamination of the leading portion of the web to the substrate begins. As a result, the rollers of the lamination station can be used to transport the lamina, thereby avoiding the need for a separate transport mechanism for transporting the lamina to the lamination station.

### PRIORITY DATA

This application claims the benefit of Provisional Application No. 60/395,601, filed Jul. 11, 2002, which is incorporated by reference herein in its entirety.

### FIELD OF THE INVENTION

This invention relates to lamination equipment used to laminate data bearing identification and financial documents, including plastic cards such as financial (e.g. credit and debit) cards, drivers' licenses, national identification cards, and other similar cards, as well other identification and financial documents, such as passports, by applying a plastic top coat to the documents.

### BACKGROUND OF THE INVENTION

The use of laminated identification and financial documents, such as financial (e.g. credit and debit) cards, drivers' licenses, national identification cards, and other like cards, as well as passports and the like, is well known. The documents are typically provided with one or more of printed characters and/or images, holographic images, embossed characters, laser-produced information, and data storage media such as an integrated circuit chip. To protect the document and the information provided thereon, it is common to provide a top coat, comprising a plastic lamina, to the surface of the document. The surface of the document covered by the topcoat is usually the front surface of the document, but the rear surface can also be covered by a second topcoat, or both the front and rear surfaces can be covered by topcoats.

It is generally preferable that the lamina have a size that approximates the surface of the document so that the entire document surface is protected. A known method for applying a topcoat to a document is to laminate to the document surface a lamina that has a size greater than the size of the document surface. The edges of the lamina that extend beyond the edges of the document are then trimmed or cut to the size of the document. An example of an apparatus that cuts a laminate film to the size of the underlying substrate is disclosed in U.S. Pat. No. 5,653,846. A drawback to these types of apparatus is that they waste laminate material, as the excess laminate material that is cut must be thrown away or recycled. This increases production costs, as the amount of laminate material that is used is greater than the amount actually needed to cover the document.

Another known method for applying a topcoat to a document is to laminate to the document surface a lamina that has a size approximately equal to the size of the document surface. Because the size of the laminate is approximately equal to the size of the document, no cutting of the laminate down to the size of the document is necessary, thereby significantly reducing waste. Examples of these wasteless laminators are disclosed in U.S. Pat. Nos. 5,783,024; 6,007,660; 6,159,327; 6,244,319; and 6,283,188, as well as WO 00/27634.

A drawback to conventional wasteless laminators is that they separate each lamina from the lamina supply roll a significant distance upstream from the lamination station. As a result, a transport mechanism is needed to transport the lamina after separation to the lamination station. The need for a transport mechanism increases the size and complexity, and thus the cost, of the laminator.

Therefore, there is a need for an improved wasteless laminator that has less complexity and size, and less cost, than conventional wasteless laminators.

### SUMMARY OF THE INVENTION

The invention relates to a wasteless lamination mechanism that laminates a topcoat or lamina onto a substrate, without requiring cutting of the lamina down to the size of the substrate. The substrate is preferably a card, such as an identification card, a credit card, or other CR80 size card. However, other substrates could be laminated using the teachings of the present invention.

In a preferred embodiment, a lamina to be laminated onto a substrate is separated from a web containing a plurality of lamina after lamination of the leading portion of the web to the substrate begins. As a result, the rollers of the lamination station can be used to transport the lamina, thereby avoiding the need for a separate transport mechanism for transporting the lamina to the lamination station.

Preferably, the web comprises a plurality of laminae separated by lines of weakness, for example perforations or scoring. Each lamina can then be separated from the web by tearing along the line of weakness. In one embodiment, separation of a lamina is initiated by an actuatable initiation mechanism, with the rollers of the lamination station completing separation. In a second embodiment, the lamina is separated by a passive separation mechanism.

In one aspect of the invention, a lamination mechanism comprises a supply of web material containing a plurality of laminae, with the web material including a leading edge. A drive mechanism that is engageable with the web material drives the leading edge thereof toward and into a lamination station. Further, a lamina separation mechanism is provided to separate a lamina from the web material. The separation mechanism is preferably positioned such that separation of the lamina occurs after the leading edge of the lamina has been laminated to the substrate.

In another aspect of the invention, a method of laminating a substrate is provided. The method includes providing a lamination mechanism that has a supply of web material containing a plurality of laminae, with the web material including a leading edge, a lamination station including a staging position, and a drive mechanism engageable with the web material for driving the leading edge thereof toward and into the lamination station. The leading edge of the web material is advanced to the staging position, as is the substrate. The leading edge of the web material is then laminated to the substrate. Thereafter, a lamina is separated from the web material. The separated lamina includes the leading edge that has been laminated to the substrate. Thereafter, lamination of the lamina to the substrate is completed.

For a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

FIG. 1 is a schematic view of a wasteless lamination mechanism according to the present invention.

FIG. 2 illustrates a portion of the perforated supply roll that supplies the laminates.

FIG. 3 illustrates a laminate applied to a card substrate.

FIG. 4 illustrates an alternate embodiment of a laminate applied to a card substrate.

FIG. 5 illustrates an alternate embodiment of a wasteless lamination mechanism according to the present invention.

FIG. 6 sets forth the method of operation of the lamination mechanism.

### DETAILED DESCRIPTION OF THE INVENTION

The invention relates to a wasteless lamination mechanism for laminating a substrate with a protective plastic topcoat or lamina. Substrates with which the invention is preferably used includes plastic cards, such as financial (e.g. debit and credit) cards, driver's licenses, and identification cards. However, the invention can also be used with other identification and/or financial document substrates, including passports, and other substrates that benefit from having a protective topcoat laminated thereto. For sake of convenience, the word “substrate” as used herein and in the claims is intended to refer to and encompass each of these different types of documents. When a lamina is applied to a specific type of substrate, the name of the substrate will be recited.

The term “wasteless” as used herein means the application of a lamina to a substrate, where the size of the lamina is approximately equal to or less than the size of the substrate, so that the lamina does not need to be cut or trimmed to remove lamina material overhanging one or more edges of the substrate. Further, the laminae are not carried by a carrier material, so there is no take-up roll to take-up the carrier material after the laminae are removed therefrom as is required in some conventional non-wasteless laminators.

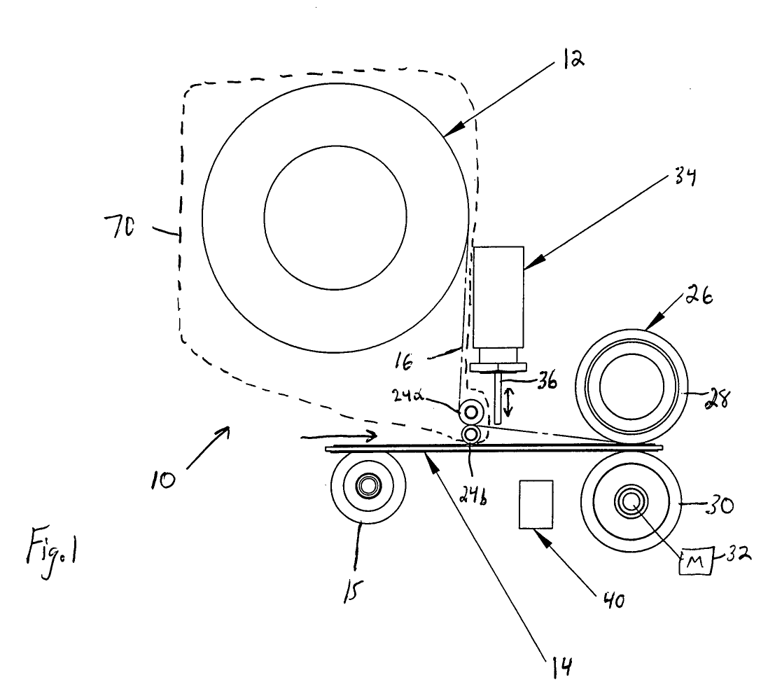

With reference to FIG. 1, a lamination mechanism 10 according to the present invention is illustrated. The mechanism 10 includes a lamina supply roll 12 that supplies the laminae that are to be laminated onto substrates. In FIG. 1, the substrate is illustrated as being a card 14, such as a credit card or other CR80 size card, that is supplied to the lamination mechanism 10 from an upstream location via an infeed mechanism 15. The card 14 can be supplied directly from an input hopper containing a plurality of cards waiting to be laminated, in which case the lamination mechanism 10 is a stand alone system. The card 14 can also be supplied from a personalization mechanism, such as a printer, positioned upstream from the lamination mechanism 10 so that the card is laminated immediately after being personalized, in which case the lamination mechanism 10 is part of system that includes personalization capability.

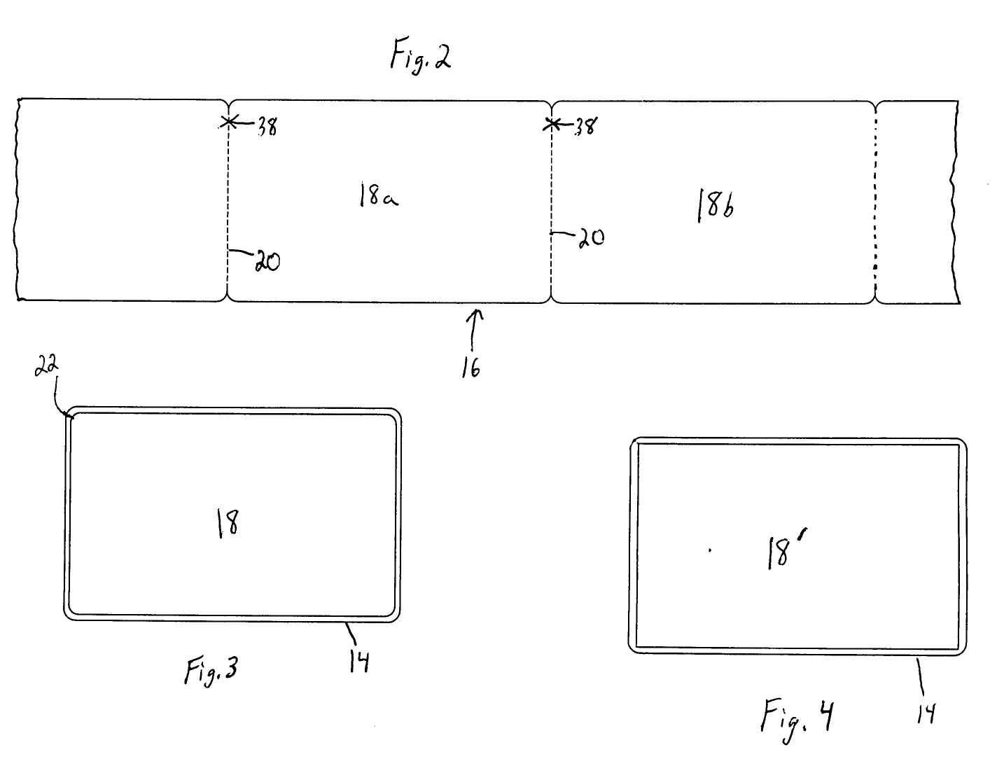

The lamina supply roll 12 comprises a web 16 of plastic material from which an individual lamina to be laminated onto a substrate is provided. With reference to FIGS. 2 and 3, a portion of the web 16 is illustrated. The web 16 comprises a series of laminae 18a, 18b, . . . 18n, with each lamina having a size that is slightly smaller than the size of the substrate, as is illustrated in FIG. 3 which shows lamina 18 laminated to the card 14. The laminae are separated by weakened lines 20 of connection that permit each lamina to be separated from the remainder of the web 16. The weakened lines 20 preferably comprise perforations. The perforated lines 20 are preferably pre-formed in the web 16, although the mechanism 10 could be provided with a perforation mechanism that forms the perforated lines 20 at the appropriate locations on the web 16 after the roll 12 is loaded into the mechanism.

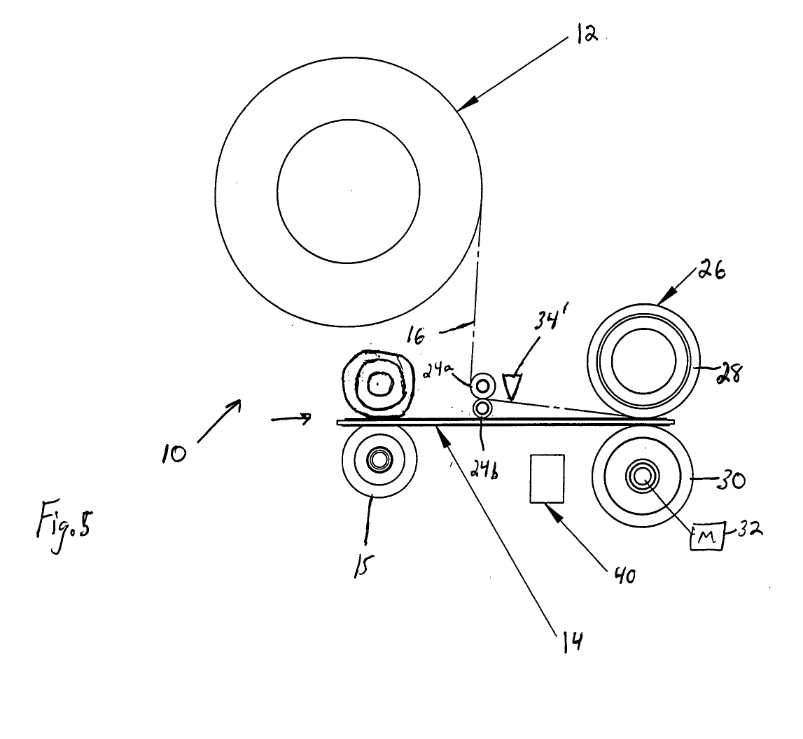

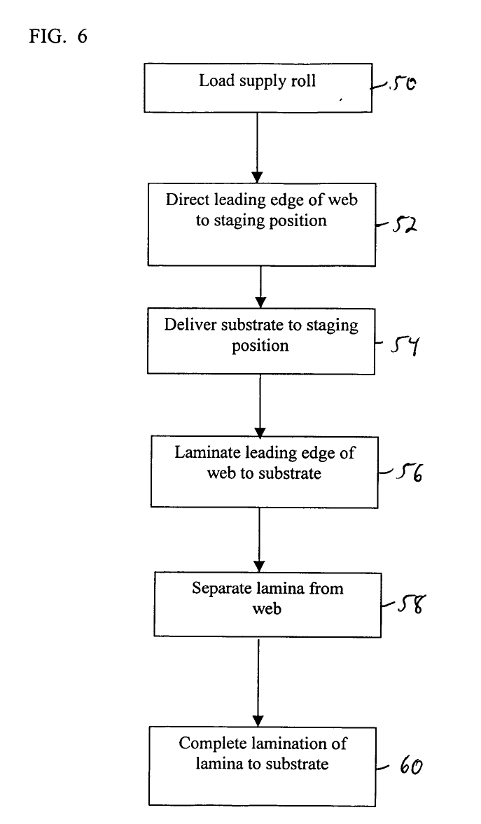

As shown in FIGS. 2 and 3, each lamina is preferably formed with radiused corners 22 that correspond to the radiused corners of the card 14. The use of radiused corners 22 on the lamina allow the lamina to more closely match the size of the card 14, thereby minimizing the gap created between the edges of the lamina and the edges of the card. The lamina could have square corners if desired, as shown by the lamina 18′ in FIG. 4. However, the use of square corners would result in larger gaps being created between the edges of the lamina and the edges of the card.

Returning now to FIG. 1, the web 16 is directed through a pair of drive rollers 24a, 24b which are used to advance the web 16 toward a lamination station 26. The lamination station 26 comprises a heated roller 28 and a roller 30 positioned opposite the heated roller. The rollers 28, 30 form a heated nip between which the lamina and the substrate pass during the lamination procedure. The rollers 28, 30 are driven by a motor 32, preferably a stepper motor, for advancing the substrate and lamina during lamination and driving the laminated substrate out of the mechanism 10.

The mechanism 10 further includes a lamina separation mechanism 34 positioned along the travel path of the web 16 between the drive rollers 24a, 24b and the lamination station 26. In the preferred embodiment illustrated in FIG. 1, the mechanism 34 is an active mechanism that is actuated into contact with the web 16 to initiate separation of each lamina 18 from the web 16. The mechanism 34 preferably includes a finger 36 that is actuatable in a downward direction toward and into engagement with the web 16 to initiate separation of each lamina. After lamina separation is initiated, the finger 36 is retracted back to the position shown in FIG. 1 waiting to be actuated when the next lamina is to be separated.

The mechanism 34 and finger 36 are positioned so that the finger 36 engages the web 16 along the perforated line 20 at a position 38 adjacent one edge of the web 16, as shown in FIG. 2. This engagement initiates the separation. The remainder of the separation occurs as a result of the rollers 28, 30 pulling the leading portion of the lamina and the substrate through the lamination station 26, while at the same time the drive rollers 24a, 24b slow down or stop to provide a differential speed between the web 16 and the lamina to be separated from the web.

Other lamina separation mechanisms could be used within the scope of the invention. For example, a passive mechanism 34′ could be used as shown in FIG. 5. The passive mechanism 34′ preferably resides between the drive rollers 24a, 24b and the lamination station 26, and is fixed in a position so that it engages the web 16 to initiate separation, with separation being completed by the rollers 28, 30.

A sensor 40, for example a reflective sensor, is provided to sense the leading edge of the web 16. The sensor 40 enables the lamina and the substrate to be aligned relative to one another to achieve proper lamination.

With reference now to FIG. 5, the operation of the lamination mechanism 10 will be described. As an initial matter, at step 50, the supply roll 12 comprising the web 16 of laminae is loaded into the mechanism 10. Next, at step 52, the leading edge of the web 16 is then advanced by the drive rollers 24a, 24b to the lamination station 26. As the leading edge of the web 16 is being advanced, the sensor 40 senses the leading edge. The leading edge of the web 16 is advanced to a staging position slightly upstream from the heated nip between the rollers 28, 30. This keeps the leading edge of the web 16 outside of the heating zone in the nip to protect the lamina from degradation.

The substrate 14 is also advanced to the staging position, at step 54. By advancing both the leading edge of the web 16 and the substrate 14 to the staging position, alignment of the lamina and the substrate are achieved. The web and the substrate are then simultaneously driven into the heated nip, and the leading edge of the web is laminated to the substrate at step 56.

At step 58, the lamina is separated from the web 16. To achieve separation, as lamination progresses, the drive rollers 24a, 24b will stop and the separation mechanism will engage the web 16 along the perforated line 20 to initiate separation of a lamina from the web. Continued rotation of the rollers 28, 30 will complete the separation by finishing tearing of the lamina from the web 16 along the perforated line 20. Because separation of the lamina occurs between the drive rollers 24a, 24b and the lamination station 26, and the rollers 28, 30 are already engaged with the lamina, an additional transport mechanism for handling and transporting the lamina is avoided. Further, the drive rollers 24a, 24b remain engaged with the new leading edge of the web, so that a new lamination procedure can then begin.

At step 60, lamination of the lamina to the substrate is then completed. The laminated substrate can then be driven out of the mechanism 10 for subsequent handling, for example stacking within a hopper.

The mechanism 10 thus provides simple, wasteless lamination, without requiring cutting of the lamination material or requiring a mechanism to transport the lamina to the lamination station after separation. To further simplify operation of the mechanism 10, the supply roll 12 and drive rollers 24a, 24b can be provided in a cassette structure 70, illustrated in dashed lines in FIG. 1. The use of a cassette 70 simplifies loading of the supply roll, and facilitates alignment and smooth feeding of the web 16.

The above specification, examples and date provide a complete description of the invention. Many embodiments of the invention, not explicitly described herein, can be made without departing from the spirit and scope of the invention.

What is claimed is:

1. A lamination mechanism, comprising:
a supply of web material containing a plurality of laminae, said web material including a leading edge;
a lamination station;
a drive mechanism engageable with the web material for driving the leading edge thereof toward and into the lamination station; and
a lamina separation mechanism that is positioned within the mechanism at a position so that a lamina is separated from the web after the leading edge of the web material is laminated to a substrate.

2. The lamination mechanism according to claim 1, wherein the lamina separation mechanism is positioned between the drive mechanism and the lamination station.

3. The lamination mechanism according to claim 1, further including a sensor for sensing the leading edge of the web material.

4. The lamination mechanism according to claim 1, wherein said web material comprises a plurality of laminae separated by lines of weakness.

5. The lamination mechanism according to claim 4, wherein the lines of weakness are formed by perforations.

6. The lamination mechanism according to claim 4, wherein each lamina has either radiused or square corners, and each said lamina has a size that approximates a card-shaped substrate.

7. The lamination mechanism according to claim 4, wherein the lamina separation mechanism comprises a mechanism that is actuatable into engagement with the web material adjacent the lines of weakness.

8. The lamination mechanism according to claim 4, wherein the lamina separation mechanism comprises a structure that is fixed in position.

9. The lamination mechanism according to claim 1, wherein the lamination station comprises a pair of rollers, at least one of said rollers being heated, and further including a motor in driving engagement with each said roller.

10. The lamination mechanism according to claim 1, wherein the drive mechanism comprises a pair of drive rollers.

11. The lamination mechanism according to claim 1, wherein the supply of web material and the drive mechanism are provided in a cassette.

12. A method of laminating a substrate, comprising:
providing a lamination mechanism that includes:
i) a supply of web material containing a plurality of laminae, said web material including a leading edge;
ii) a lamination station including a staging position; and
iii) a drive mechanism engageable with the web material for driving the leading edge thereof toward and into the lamination station;
advancing the leading edge of the web material to the staging position;
advancing the substrate to the staging position;
laminating the leading edge of the web material to the substrate;
separating a lamina from the web material, the lamina including the leading edge that has been laminated to the substrate; and
completing lamination of the lamina to the substrate.

13. The method according to claim 12, wherein separating occurs between the drive mechanism and the lamination station.

14. The method according to claim 12, wherein separating comprises initiating separation of the lamina from the web material, and then completing separation.

15. The method according to claim 12, further including sensing the leading edge of the web material between the drive mechanism and the lamination station.

16. The method according to claim 12, comprising laminating a substrate that is card-shaped.

17. The method according to claim 16, comprising laminating the card-shaped substrate with a lamina that has either radiused corners or square corners.
